(19) United States
(12) Patent Application Publication
(10) Pub. No.: US 2010/0321295 A1
(43) Pub. Date: Dec. 23, 2010

(54) Integration type remote control device and its wireless manipulation method

(76) Inventor: Chung- Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,610

(22) Filed: Jun. 17, 2009

(51) Int. Cl. G06F 3/033; G06F 3/02

(52) U.S. Cl. 345/163; 345/168

(57) ABSTRACT

This invention relates to an integration type remote control device and its wireless manipulation method. The remote control is essentially provided with a keyboard input interface and a mouse control knob, and a microprocessor in its interior is connected to a wireless transmission module, an acceleration sensing element for sensing and manipulating the moving of cursor of the computer mouse, and a gyroscope sensing element such that the remote control device can link with a dongle plugged in the computer by the wireless transmission module and manipulate the computer by the keyboard input interface. In the moving process of the remote control, the sensing of both the acceleration sensing element and the gyroscope sensing element are utilized to manipulate the moving of cursor of the computer mouse, and the mouse control knob is utilized to execute the manipulation of cursor of computer mouse. In this manner, the computer keyboard and mouse is integrated and is manipulated by wireless mode so as to manipulate directly the input of computer. It can increase more practical effectiveness in the entire implementation and usage thereof.

### BACKGROUND OF THE INVENTION

1. Field of the Invention

This invention relates to an integration type remote control device and its wireless manipulation method, especially to a novel integration type remote control device and its wireless manipulation method, in which computer keyboard and mouse is integrated and is manipulated by wireless mode so as to directly manipulate or to input with respect to the computer, hence more practical effectiveness in its entire implementation and usage can be increased.

2. Brief Description of the Prior Art

In the modern society increasingly progressive in science and technology, a variety of computer equipments flood everywhere in livehood and ambience of people, among which the personal computer equipment almost becomes one of indispensable items of every household. Personal computer not only allows people to conduct data processing or word processing etc. but also allows people access to the internet for searching a variety of required resource and information. Additionally, in view of the rapid development in the computer equipment and concerned peripheral facilities, more and more people watch a variety of multimedia AV informations by using personal computer. Moreover, due to the successful experience of You Tube, more and more video sharing websites are come with the tide of fashion such that people become easier to get more movie or music information from personal computer.

In the operation and usage of computer, keyboard and mouse are indispensable items. In early stage, general keyboard and mouse are respectively linked with computer host machine by lead wires so that the manipulation signals of keyboard and mouse are respectively transmit to computer host machine by lead wires for the computer host machine to react correspondingly. However, inasmuch as the length of lead wire is limited, the set up locations of keyboard and mouse are also restricted. Moreover, the computer host machine has to connect with peripheral equipments such as power source, monitor, internet, speaker by a variety of lead wires which are not only inconvenient in the set up of the whole system but also looks very confused and in disorder.

In view of the above shortcomings, wireless keyboard and wireless mouse are proposed by the industries, as shown in FIG. 6 of a conventional structure, a dongle (22) is plugged and locked in the USB slot (211) of the computer host machine (21), and a wireless keyboard (23) and a wireless mouse (24) are respectively provided with respect to the dongle (22). Wireless transmitters (not shown in figures) are built in the wireless keyboard (23) and the wireless mouse (24) so that the manipulation signals of the wireless keyboard (23) and the wireless mouse (24) will transmit to the outside through the wireless transmitters, when the wireless keyboard (23) and the wireless mouse (24) are used to manipulate the computer host machine (21). When the dongle (22) plugged and locked in the USB slot (211) of the computer host machine (21) receives the manipulation signals, the manipulation signals are transmitted into the computer host machine (21) so as to manipulate the computer host machine (21).

The abovementioned wireless keyboard and the wireless mouse can achieve the expected effectiveness of conducting wireless manipulation without limitation by the lead wire, but it is found in practical implementation that the wireless keyboard and a wireless mouse are designed to be separate structures, that is to say that enough space has to be provided for the arrangement of the separated wireless keyboard and the wireless mouse. This design not only takes a lot of space but also users in the usage have to change hands to manipulate the wireless keyboard and the wireless mouse respectively. Aside from this, the wireless mouse still did not change the tradition of slipping on tabletop without having instinct type, telepresence feeling and convenience with respect to some computer games, and this will results in great inconvenience in its operation and usage. Therefore, the wireless keyboard and the wireless mouse still have space for improvement in the integral implementation and usage thereof.

In view of the above facts, inventor of the present invention provides an integration type remote control device and its wireless manipulation method according to the research and improvement conducted on the shortcomings of the existing structure based on his abundant experience of R&D and manufacturing in relevant field so as to achieve the goal of obtaining better practical value in implementation.

### SUMMARY OF THE INVENTION

In the integration type remote control device and its wireless manipulation method of this invention, the remote control is essentially provided with a keyboard input interface and a mouse control knob, and in its interior a microprocessor is used to connected to a wireless transmission module, an acceleration sensing element for sensing and manipulating the moving of cursor of the computer mouse, and a gyroscope sensing element such that the remote control device can link with a dongle plugged in the computer by the wireless transmission module and manipulate the computer by the keyboard input interface; in the moving process of the remote control, the sensing of both the acceleration sensing element and the gyroscope sensing element being utilized to manipulate the moving of cursor of the computer mouse, and the mouse control knob being utilized to execute the manipulation of cursor of the computer mouse. In this manner, the computer keyboard and the mouse are integrated and are manipulated by wireless mode so as to directly manipulate and input with respect to the computer. Thus, it can increase more practical effectiveness in the entire implementation and usage thereof.

### BRIEF DESCRIPTION OF THE DRAWINGS

FIG. 1 is a perspective view showing the appearance of the present invention.

FIG. 2 is a top view showing the structure of the present invention.

FIG. 3 is a block diagram showing the structure of the present invention.

FIG. 4 is a flow chart of the wireless manipulation method of the present invention implemented in the computer.

FIG. 5 is a flow chart of the wireless manipulation method of the present invention implemented in the AV play device.

FIG. 6 is a schematic view showing a conventional structure.

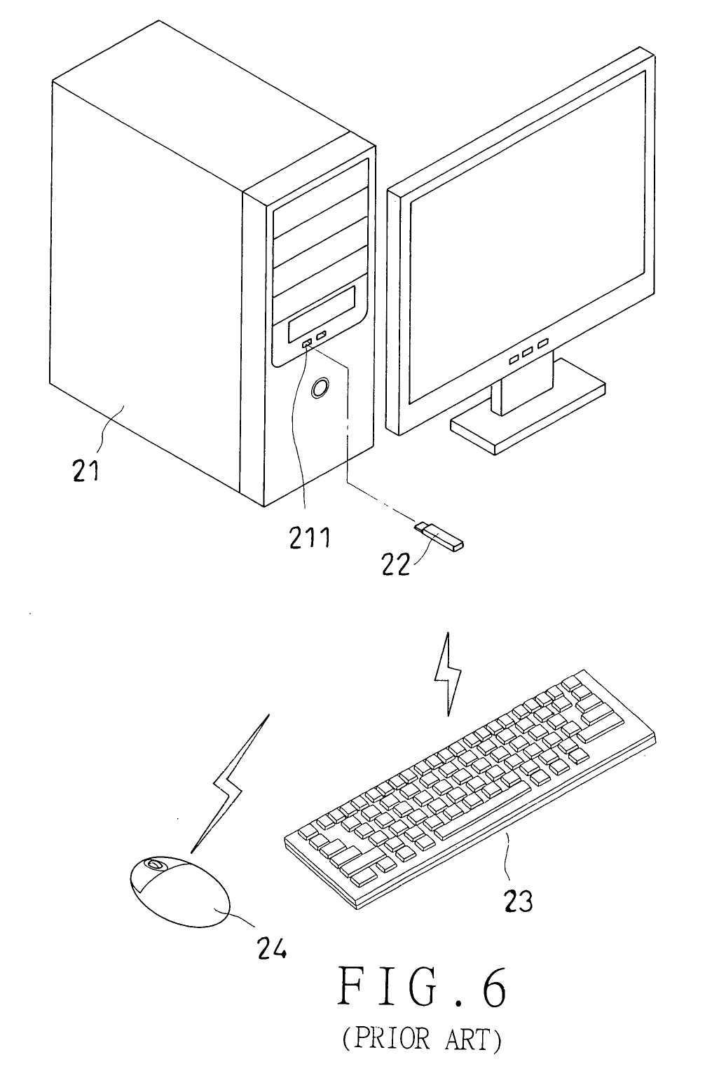

### DETAILED DESCRIPTION OF PREFERRED EMBODIMENTS

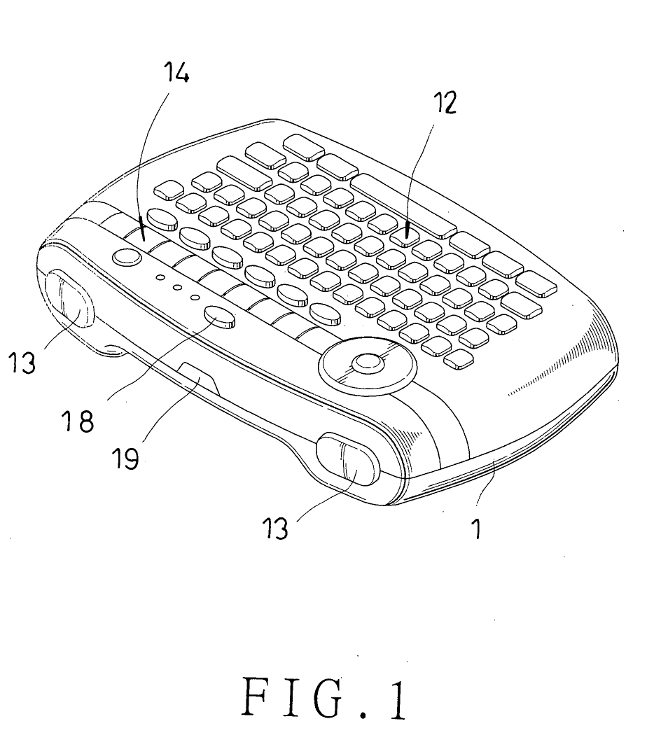

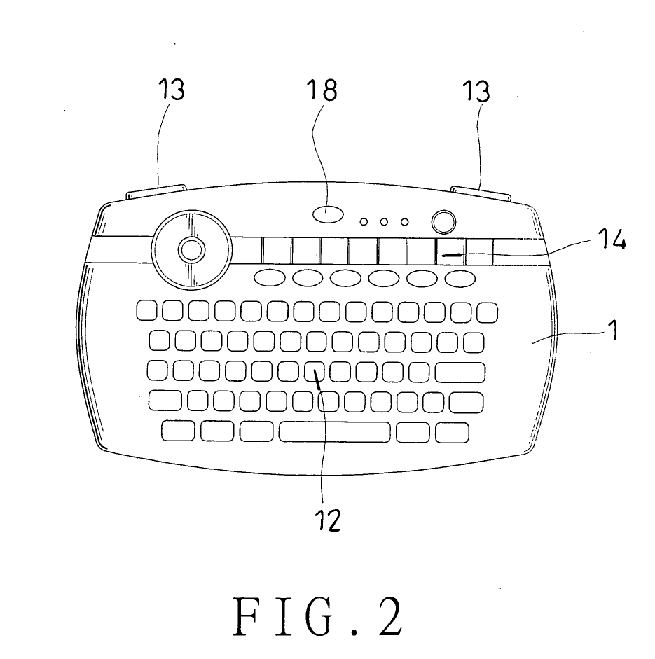

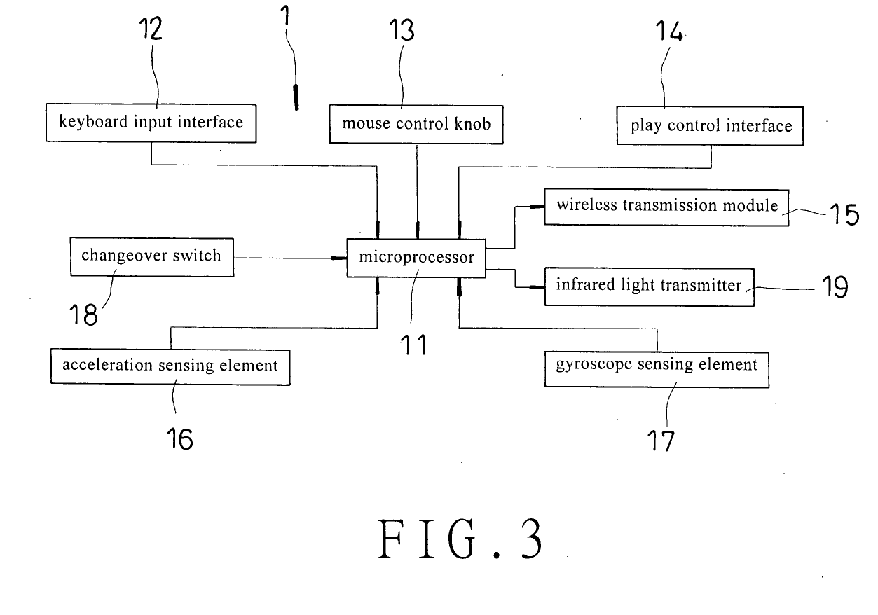

FIG. 1 is a perspective view showing the appearance of the present invention; FIG. 2 is a top view showing the structure of the present invention; and FIG. 3 is a block diagram showing the structure of the present invention. As shown in these figures, the remote control device (1) of the present invention is essentially provided with a microprocessor (11) which is connected, at the outside of the remote control device (1), to a keyboard input interface (12) adapted to manipulate the activation of computer by keyboard, and to a mouse control knob (13) adapted to manipulate the activation of computer by mouse, and to a play control interface (14) adapted to manipulate the activation of AV information. A wireless transmission module (15) connected to the microprocessor (11) and adapted to link with computer for wireless transmission, an acceleration sensing element (16) and a gyroscope sensing element (17) for sensing and manipulating the moving of cursor of computer mouse are provided in the interior of the remote control device (1).

In this manner, when the remote control device (1) is started, the wireless transmission module (15) can link in wireless mode with the dongle (which can also formed as a module built in the computer host machine) plugged in the computer to conduct the transmission of command information. When users use the keyboard input interface (12) to operate the computer or the play control interface (14), the command information issued by user is transmitted by the wireless transmission module (15) in wireless mode to the dongle plugged in the computer so that the computer executes either the action with respect to the command information or execute the command information of the play control interface (14) to operate and to control the AV play program for conducting the play of AV information. When the remote control device (1) is moved instead of inputting command through the keyboard input interface (12), the acceleration sensing element (16) and the gyroscope sensing element (17) connected to the microprocessor (11) of the remote control device (1) can sense and compute the moving speed, the direction parameter of the remote control device (1), and the displacement of cursor on the computer screen is responded after the computing process of the microprocessor (11). Besides, the mouse control knob (13) on the remote control device (1) is used to conduct the “option” and “setting operation”, then the goal of integrating the wireless keyboard, wireless mouse to manipulate the computer in wireless mode can be achieved.

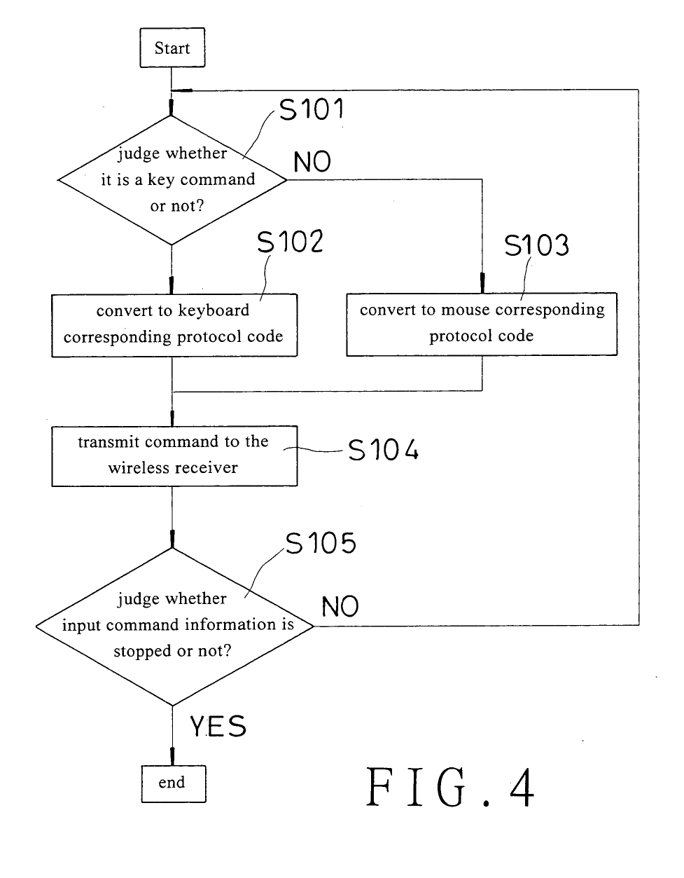

FIG. 4 is a flow chart of wireless manipulation method of the present invention implemented in the computer, in which:

S101: judge whether it is a key command or not. When users start to manipulate the remote control device (1), if a key command is input by the keyboard input interface (12) or play control interface (14), then shift to step S102; if not a keyboard command, then shift to step S103;

S102: convert to keyboard corresponding protocol code;

S103: convert to mouse corresponding protocol code; compute the displacement position of cursor of computer mouse by means of the acceleration sensing element (16), the gyroscope sensing element (17) or convert the input protocol code of the mouse control knob (13);

S104: transmit command to the wireless receiver. The above command protocol code is transmitted to the dongle connected to the computer by the wireless transmission module (15) so that the computer conducts the action with respect to the command.

S105: judge whether input command information is stopped or not. Judge whether the above keyboard input interface (12), mouse control knob (13), play control interface (14), acceleration sensing element (16), gyroscope sensing element (17) stops command information or not. If not stop, continue to conduct steps S110˜S104; if input command information is stopped, then go to end.

Additionally, the remote control device (1) is further provided a changeover switch (18) and an infrared light transmitter (19). The changeover switch (18) can change the remote control device (1) to the mode for the device to be controlled such as computer or AV play device. When the AV play device is to be manipulated, the changeover switch (18) on the remote control device (1) is pressed to change to the mode with respect to the AV play device and then the play control interface (14) is utilized. The signals transmitted by the infrared light transmitter (19) are transmitted to the AV play device so as to conduct the actions of play, stop, forward, reverse, and pause.

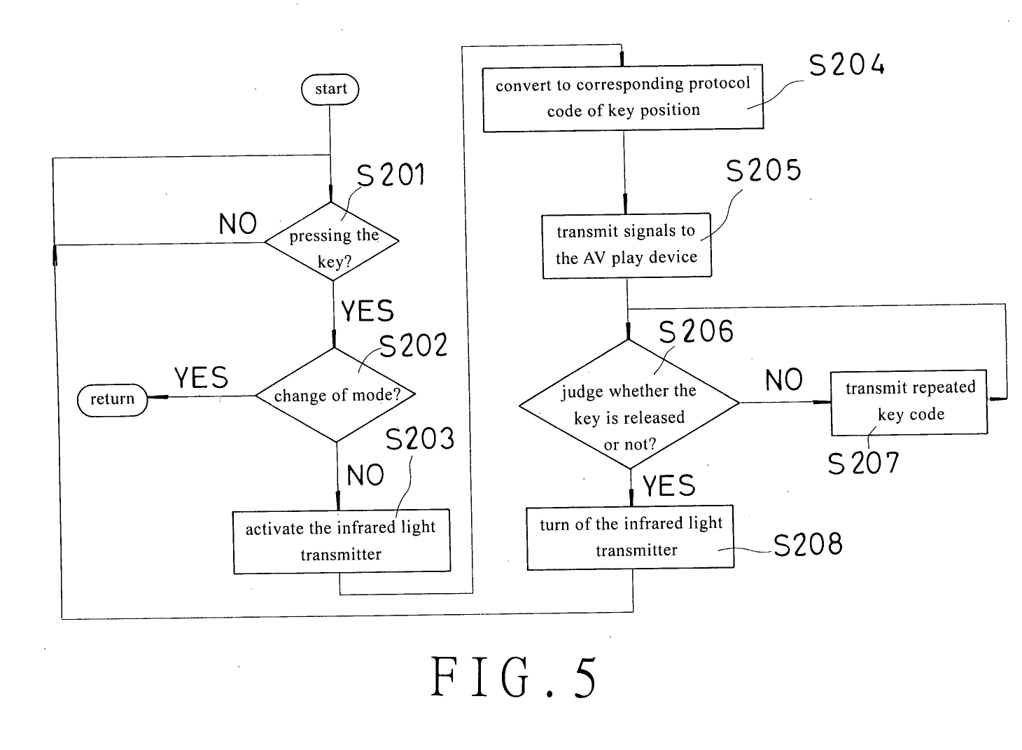

When user presses the changeover switch (18) of the present invention to the mode with respect to the AV play device, referring the FIG. 5 showing the flow chart of wireless manipulation method of the present invention applied to the mode with respect to AV play device, in which:

S201: judge whether the key of the remote control device (1) is pressed. If no key is pressed, continue to wait the input of key-pressing; if key is pressed, then shift to step S202;

S202: judge whether the input command is mode change. If it is mode-change, then return to the mode of manipulating the computer; if the input command is not mode-change, then shift to step S203;

S203: activate the infrared light transmitter (19) of the remote control device (1);

S204: convert to corresponding protocol code of key position;

S205: transmit signals to the AV play device such that the command produced by users operating the remote control device (1) is received by the AV play device. In this manner, associated operation of option, play, forward, stop can be conducted on the AV files outputted to the AV play device;

S206: judge whether the key is released or not. If not released, then shift to step S207; if released, then shift to step S208;

S207: transmit repeated key code;

S208: turn of the infrared light transmitter (19) and return to step S201.

Based on the foregoing, the integration type remote control device of the present invention has the following advantages when comparing with the conventional structure.
1. In the integration type remote control device of the present invention, the wireless transmission module is linked with the dongle (which can also formed as a module built in the computer host machine) plugged in the computer such that the computer is manipulated by the keyboard input interface, and in the moving process of the remote control device, the moving of cursor of the computer mouse is manipulated by the sensing of the acceleration sensing element and the gyroscope sensing element, and the mouse control knob is utilized to execute the manipulation of cursor of the computer mouse. In this manner, the computer keyboard and mouse is integrated and is manipulated in wireless mode so as to directly manipulate and conduct input with respect to the computer. It can increase more practical effectiveness in the entire implementation and usage thereof.
2. The remote control device of the present invention manipulates the moving of cursor of the computer mouse by the sensing of the acceleration sensing element and the gyroscope sensing element. Thus, the remote control device of the present invention is not restricted to be put on tabletop for usage. When playing some computer games such as shooting game, racing car driving game, the remote control device can conduct manipulation in the air by direct simulation of real atmosphere. Therefore, much fun and telepresence of the game is enhanced.
3. In the present invention, a changeover switch is further provided in the remote control device for switching the manipulation state with respect to the AV play device or the computer. The remote control device not only can be used as the wireless mouse or keyboard for directly manipulating or setting the computer, but also can be used to manipulating the AV play device. Therefore, it can increase more practical convenience in the integral implementation thereof.

The abovementioned embodiments and drawings are not used to limit of the product structure or usage mode of the present invention. Equivalent variations and modifications made by the person skilled in the art without departing from the spirit and scope of the present invention are still considered to be within the scope of the present invention.

Summing up above, the above embodiment of this invention can reach expected effectiveness, and the flow path and the manipulation method disclosed herein have yet not seen in the prior art of the same category of product, even has not been opened to the public before application.

What is claimed is:

1. An integration type remote control device, which is essentially provided with a microprocessor that is connected, at the outside of said remote control device, to a keyboard input interface for manipulating the action of computer by keyboard; and to a mouse control knob for manipulating the action of computer by mouse; and to a play control interface for manipulating the action of AV information; an wireless transmission module connected with said microprocessor for linking with computer in wireless transmission mode, an acceleration sensing element and a gyroscope sensing element for sensing and manipulating the moving of cursor of computer mouse being provided in the interior of said remote control device.

2. An integration type remote control device as claimed in claim 1, wherein said remote control device is further provided a changeover switch for switching the state of manipulation with respect to the AV play device, and an infrared light transmitter is connected to said microprocessor for transmitting the manipulating signals with respect to the AV play device.

3. An wireless manipulation method of the integration type remote control device with respect to computer, comprising the following steps:
(a) Judge whether it is a key command or not. If it is a key command, then convert to keyboard corresponding protocol code; if not a key command, then convert to mouse corresponding protocol code;
(b) transmit command to the dongle linked with the computer so that the dongle receives the command produced by operating the remote control device from users so as to conduct corresponding manipulation with respect to the computer;
(c) Judge whether input command information is stopped or not. If not stop, continue the action; if it is stopped, then go to end.

4. A wireless manipulation method of the integration type remote control device with respect to computer as claimed in claim 3, wherein said keyboard corresponding protocol code is the command information of the keyboard input interface.

5. A wireless manipulation method of the integration type remote control device with respect to computer as claimed in claim 3, wherein said keyboard corresponding protocol code is the command information of the play control interface.

6. A wireless manipulation method of the integration type remote control device with respect to computer as claimed in claim 3, wherein said mouse corresponding protocol code is the moving speed and direction of said remote control device sensed and computed by the acceleration sensing element and the gyroscope sensing element.

7. A wireless manipulation method of the integration type remote control device with respect to computer as claimed in claim 3, wherein said mouse corresponding protocol code is the command information of the mouse control knob.
